(19) United States
(12) Patent Application Publication
(10) Pub. No.: US 2003/0129977 A1
(43) Pub. Date: Jul. 10, 2003

(54) Emergency rescue aid

(75) Inventor: Anthony Craig Dolwin, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/293,319

(22) Filed: Nov. 14, 2002

(30) Foreign Application Priority Data
Nov. 14, 2001 (GB) 0127339.0

(51) Int. Cl. H04Q 7/20

(52) U.S. Cl. 455/422; 455/567

(57) ABSTRACT

This invention is concerned with methods of using mobile phones to locate trapped or buried victims of natural or man-made disasters. In an embodiment of the method a mobile phone sends an alert request signal to an emergency alert controller which then broadcasts an emergency alert message to all the other mobile communications devices in the same cell or sector as the first, alert requesting phone. In response all these other mobile communications devices each output an emergency alert response such as a very loud audio tone or rf beacon signal.

### FIELD OF THE INVENTION

This invention is generally concerned with the use of a mobile phone system to facilitate emergency search and rescue. In particular it is concerned with methods of using mobile phones to locate trapped or buried victims of natural or man-made disasters.

### BACKGROUND TO THE INVENTION

In emergency situations such as those created by an avalanche, earthquake or terrorist attack it is imperative that individuals be found as soon as possible to reduce the loss of life. However emergency services can often take some time to arrive, particularly where the event has taken place in an inaccessible location. Furthermore the emergency services often rely on specialised equipment for search and rescue and there is often a delay in obtaining such equipment and transporting it to the site of the emergency. In the case of an avalanche survival expectancy falls exponentially to zero over a period of 1 to 2 hours and any delay may therefore have tragic consequences. Members of the general public will usually do what they can prior to emergency services arriving but are often hampered by lack of appropriate tools.

To protect against the risk of an avalanche mountaineers will sometimes carry a so-called “avalanche bleeper” which is switched on at the start of an expedition and provides an rf transmission modulated with an audio tone which, should the wearer be buried under an avalanche, can be used to locate the victim. However these avalanche bleepers are not generally worn, they have a relatively short battery life, and although not expensive to hire they are usually considered unnecessary by recreational skiers, even when off-piste.

Nowadays many people carry a mobile phone and the present invention is aimed at facilitating the location of trapped or buried victims of disasters using a mobile phone network.

### SUMMARY OF THE INVENTION

According to the present invention there is therefore provided a method of using a communications system to assist in locating one or more mobile communications devices, the communications system including a mobile phone network to which the mobile communications systems devices are attached, the method comprising, receiving an alert request signal at the mobile phone network; and broadcasting an alert message to a plurality of said mobile communications devices in response to said alert request, said alert message comprising a message to cause each of said plurality of mobile communications devices to output an alert response to aid the location of the mobile communications device.

The method can be employed with a standard mobile phone that many people carry at all times. The cost of adding the alert facility to a mobile phone is minimal. Many mobile phone networks have an in-built broadcasting facility, although such a facility could be implemented separately or could even comprise separately dialling up each of the plurality of mobile communication devices. The alert response may comprise the phone's normal ringing tone but preferably uses the ringing device of the phone to provide a special alarm tone, preferably at high, or preferably increasing volume. The alert request signal may be received from the emergency services, once they have been alerted to the disaster, or it may be received from another mobile communications device, to allow a survivor to initiate the emergency location system so that the search for victims can be begun immediately.

In this way a survivor can use a standard mobile phone to initiate an alarm tone on all other phones in the vicinity, to help locate the victims. Preferably, therefore, the method further includes storing an identification number for the requesting phone, such as an IMSI (International Mobile Subscriber Identity), to help prevent wrongful use. Normally the geographical area covered by a mobile phone network is divided into cells, and these cells may themselves be sub-divided into sectors. Thus the mobile phones which are instructed to sound their alarm may comprise all the mobile phones in a cell or all those in one or more sectors of the cell, preferably at least the sector in which the requesting phone is located. Mobile phones in neighbouring cells or sectors may also be activated.

In an alternative embodiment the phone may be switched into an emergency mode in which it provides an rf beacon, optionally transmitting an identification signal such as the device's phone number. Alternatively both audio and rf emergency signals may be provided.

The emergency alert response of the phone may time-out after a predetermined period or, alternatively, the phone network may issue a cancel instruction after a predetermined time-out period. In embodiments the network may also selectively cancel the emergency alert response from selected mobile phones, for example in response to instructions from another phone, to allow unwanted responses to be selectively switched off. For example, the response from the alert-requesting phone may be automatically cancelled in this way. Additionally or alternatively the output may be switched off locally by a user.

To restrict the risk of false alarms the system may be subject to an enabling control, to allow the phone network and/or emergency services to control whether or not an individual mobile phone user is able to activate the system. Alternatively only parts of the mobile phone network may be enabled, for example to activate the system in ski resorts but disable the system elsewhere, except when an emergency is known to have occurred. Central control could be provided by, for example, an operations and maintenance centre of the mobile phone network.

In a related aspect the invention provides a method of using a communication system including a mobile communications device attached to a mobile phone network to aid the location of the mobile communications device, the method comprising; receiving an alert request signal at the mobile phone network; and transmitting an emergency alert message to the mobile communications device, the emergency alert message comprising a message to cause the mobile communications device to output an emergency alert response to aid the location of the mobile communications device.

In a further aspect the invention provides a method of using a mobile communications device as an emergency location aid, the method comprising; receiving an emergency alert message at the mobile communications device; and outputting an emergency alert from the mobile communications device in response to said emergency alert message.

The invention also provides computer program code to implement the above-described methods. The programme code may be provided on a data carrier or storage medium such as a hard or floppy disk, DVD-ROM or CD-ROM, or on an optical or electrical signal carrier. The program code may be associated with a single processor or may be distributed across a network in a manner known to those skilled in the art.

The invention further provides a mobile phone network emergency controller to reside within the mobile phone network infrastructure, to implement aspects of the above methods performed by the network infrastructure, and a mobile communications device to implement aspects of the above methods performed by the mobile communications device.

### BRIEF DESCRIPTION OF THE DRAWINGS

These and other aspects of the present invention will now be further described by way of example only, with reference to the accompanying figures in which:

FIG. 1 shows elements of a mobile phone network;

FIGS. 2a and b show, respectively, an exemplary emergency situation in which the invention finds application, and a conceptual illustration of an embodiment of a method according to the present invention; and

FIG. 3 shows a communications system to implement an embodiment of the present invention.

### DETAILED DESCRIPTION OF PREFERRED EMBODIMENTS

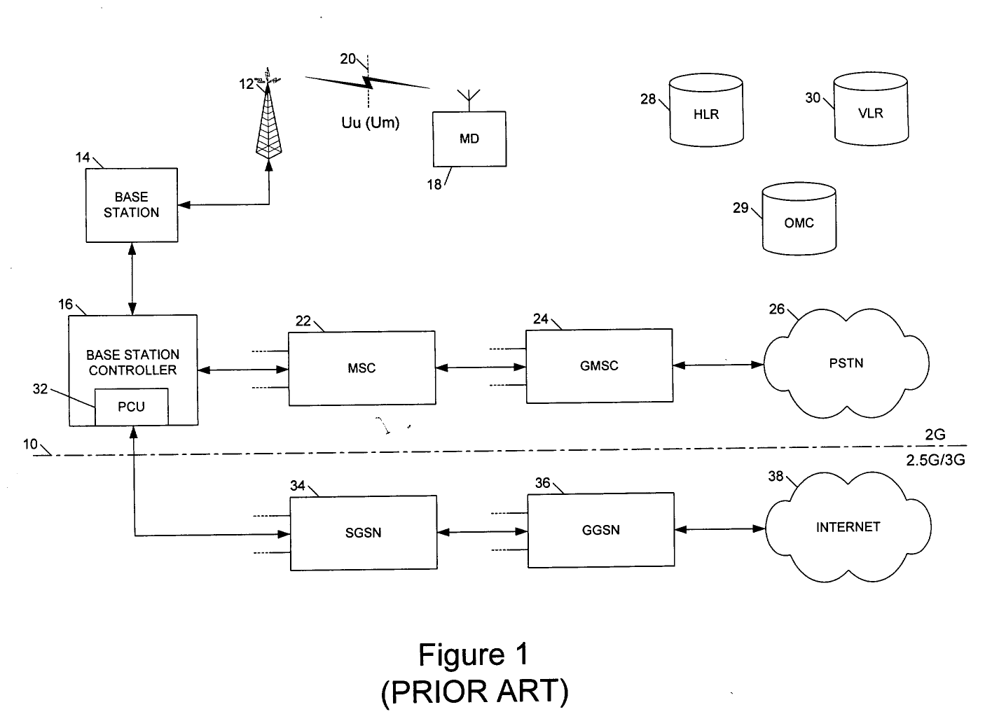

A typical digital mobile phone network is shown in FIG. 1 in which, broadly speaking, infrastructure elements above dashed line 10 are found in 2G phone networks and the elements below line 10 are the additional elements incorporated in 2.5G and 3G networks to handle packet data transmission. The basic structure of FIG. 1 is common to all digital mobile phone networks, but for convenience the network is labelled using mainly GSM terminology.

In FIG. 1 a radio mast 12 is coupled to a base station 14 which in turn is controlled by a base station controller 16. A mobile communications device 18 is shown in two-way communication with base station 14 across a radio or air interface 20, known as a Um interface in GSM and GPRS (General Packet Radio Service) networks and a Uu interface in cdma2000 and WCDMA networks. Typically at any one time a plurality of mobile devices 18 are attached to a given base station, which includes a plurality of radio transceivers to serve these devices.

Base station controller 16 is coupled, together with a plurality of other base station controllers (not shown) to a mobile switching centre (MSC) 22. A plurality of such MSCs are in turn coupled to a gateway MSC (GMSC) 24 which connects the mobile phone network to the public switched telephone network (PSTN) 26. A home location register (HLR) 28 and a visitor location register (VLR) 30 manage call routing and roaming and other systems (not shown) manage authentication, billing. An operation and maintenance centre (OMC) 29 collects the statistics from network infrastructure elements such as base stations and switches to provide network operators with a high level view of the network's performance. The OMC can be used, for example, to determine how much of the available capacity of the network or parts of the network is being used at different times of day.

The above described network infrastructure essentially manages circuit switched voice connections between a mobile communications device 18 and other mobile devices and/or PSTN 26. So-called 2.5G networks such as GPRS, and 3G networks, add packet data services to the circuit switched voice services. In broad terms a packet control unit (PCU) 32 is added to the base station controller 16 and this is connected to a packet data network such as Internet 38 by means of a hierarchical series of switches. In a GSM-based network these comprise a serving GPRS support node (SGSN) 34 and a gateway GPRS support node (GGSM) 36. It will be appreciated that both in the system of FIG. 1 and in the system described later the functionalities of elements within the network may reside on a single physical node or on separate physical nodes of the system.

Communications between the mobile device 18 and the network infrastructure generally include both data and control signals. The data may comprise digitally encoded voice data or a data modem may be employed to transparently communicate data to and from the mobile device. In a GSM-type network text and other low-bandwidth data may also be sent using the GSM Short Message Service (SMS).

In a 2.5G or 3G network mobile device 18 may provide more than a simple voice connection to another phone. For example mobile device 18 may additionally or alternatively provide access to video and/or multimedia data services, web browsing, email and other data services. Logically mobile device 18 may be considered to comprise a mobile terminal (incorporating a subscriber identity module (SIM) card) with a serial connection to terminal equipment such as a data processor or personal computer. Generally once the mobile device has attached to the network it is “always on” and user data can be transferred transparently between the device and an external data network, for example by means of standard AT commands at the mobile terminal-terminal equipment interface. Where a conventional mobile phone is employed for mobile device 18 a terminal adapter such as a GSM data card may be needed.

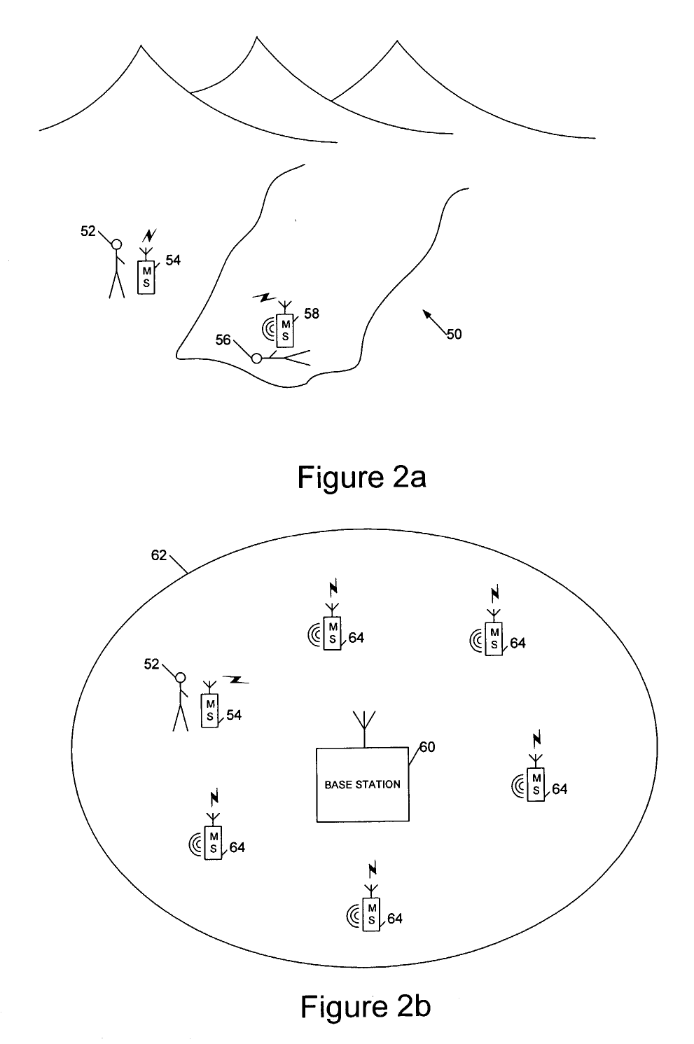

Referring now to FIGS. 2a and 2b, these show the concept underlying an embodiment of the present invention. In FIG. 2a an avalanche 50 has buried victim 56 and his or her mobile phone or mobile station (MS) 58. However providing mobile phone 58 is not too deeply buried it will still be in communication with a nearby base station. A survivor 52 also has a mobile station 54, which is used to dial the number of an emergency service, thus sending an emergency alert request to instruct the mobile phone network to broadcast an emergency alert message to all mobile terminals in the vicinity of the survivor 52. The emergency alert message is received by mobile 58 which is then caused to emit an audio and, optionally, an rf emergency alarm signal. This signal allows the survivor 52 to locate the victim 56 and hence assists his or her rescue.

Referring now to FIG. 2b, it can be seen that mobile phone 54 communicates with the base station 60 to which the mobile phone is attached, which then forwards the alert request signal to an emergency controller. The base station is then instructed to send a signal to all the mobile phones 64 within the cell 62 served by the base station, so that these mobile phones 64 begin to emit an audible alarm tone and, optionally, an rf beacon signal.

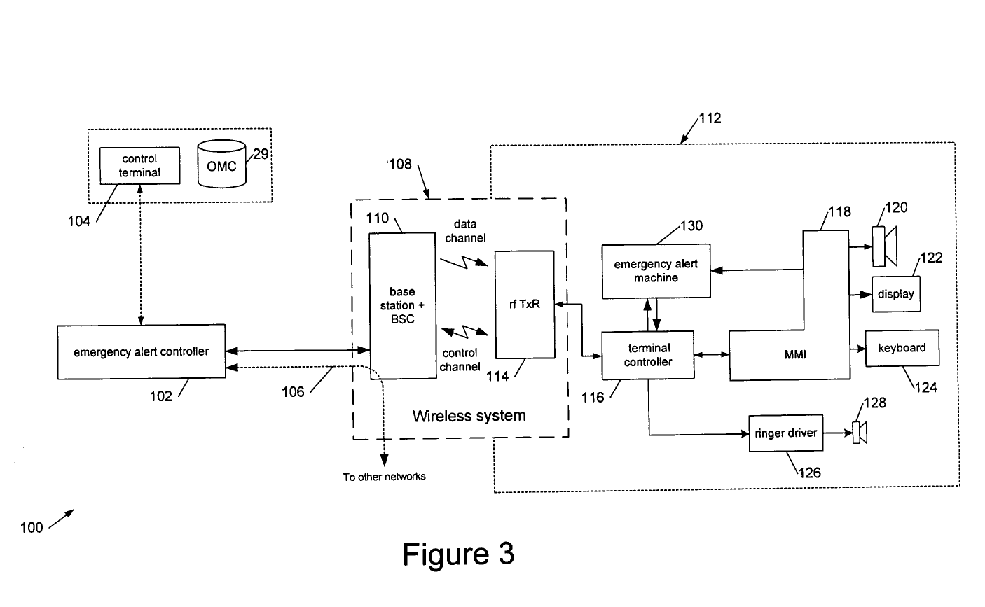

Turning now to FIG. 3, this shows an emergency alert system 100 according to an embodiment of the invention.

The system 100 comprises legacy mobile phone infrastructure components including OMC 29 and base station and base station controller 110. The legacy wireless system components are shown enclosed by dashed line 108.

The emergency alert system includes a mobile communications device 112 comprising conventional components including an rf transceiver front end 114, a terminal controller 116, a man machine interface (MMI) 118, a microphone/speaker 120, a display 122, a keyboard 124, a ringer driver 126 and a ringer 128, typically comprising a pizoelectric sounder. The terminal controller 116 comprises baseband analogue and digital circuitry and is in bi-directional data and control communication with rf transceiver front end 114. Terminal controller 116 also controls ringer 126. In embodiments of the invention ringer 128 may be replaced by a special high output device for greater range.

In addition to these conventional components the mobile communications device 112 further includes an emergency alert machine 130 in bi-directional communication with the terminal controller 116, to receive data from rf transceiver 114 and to send control messages to the terminal controller for controlling the rf transceiver 114 and for controlling ringer 126, 128. The emergency alert machine 130 receives data from rf transceiver 114 to detect an emergency alert message and sends control signals to terminal controller 116 in accordance with the detected message, to control ringer 126, 128 to sound an alarm tone and to control rf transceiver 114 to transmit an rf beacon signal from the mobile device's antenna (not shown).

On the network side an emergency alert controller 102 is shown coupled to base station controller 110, although in practice the emergency alert controller will normally comprise software installed within the base station controller or at a higher level within the network. When a survivor dials an emergency alert number using his or her mobile phone the base station controller 110 passes an emergency alert request signal, which may simply comprise the dialled number information, to the emergency alert controller which then requests cell and/or cell sector information from the base station controller to identify the approximate location of the mobile phone making the call. The emergency alert controller 102 then controls base station controller 110 to broadcast an emergency alert message to all the mobile communications devices within the relevant cell or, where the survivor is determined to be on the boundary of two cells, for example by signal strength measurements, to two (or more) relevant cells.

Where applicable the emergency alert message may only be broadcast to sectors of a cell or cells in the vicinity of the survivor making the call. Emergency alert controller 102 may also communicate with other networks, by means of a link schematically illustrated by dashed line 106, so that all the networks serving the relevant area can issue emergency alert messages.

Preferably a control terminal 104 is provided for higher level control functions, such as local and global emergency alarm enables. The control terminal is in communication with one or more emergency alert controllers via the mobile phone network infrastructure. Conveniently control terminal 104 may be collocated in the operations and maintenance centre 29. Preferably terminal 104 also provides an alternative means for controlling one or more emergency alert controllers 102 to broadcast an emergency alert message, to provide a facility for emergency services to manually control the system.

As the skilled person will recognise, both the emergency alert controller 102 and the emergency alert machine 130 will generally comprise additional software components installed, respectively, within the mobile phone network infrastructure and the mobile phone terminal. Likewise the functions of control terminal 104 may be provided by additional software running on existing terminals provided for maintenance and control functions and the like. Similarly the skilled person will recognise that the existing mobile phone network messaging and control signals may be used for communication between the emergency alert controller 102 and the emergency alert machine 130.

In use a survivor may initiate broadcast of the emergency alert message either by selecting a mode or dialling a number on his or her mobile phone or by communicating with the search and rescue authorities. To reduce the risk of improper use of this facility the telephone number of the originator of the request is preferably stored, for example in OMC database 29. In response to the request the emergency alert message is broadcast within the local cell or cell sector of the survivor and all the listening mobile phones then commence their emergency alert response. Typically this comprises a very loud audio alert tone although, to avoid causing acoustic damage to the users, preferably the tone gradually increases in volume. The alarm tone may further be arranged to time-out after a predetermined interval and may be disabled by users not affected by the incident.

Preferably the tone is selected to aid direction finding and, since lower frequencies are less rapidly attenuated than higher frequencies, preferably the tone has a frequency of less than 1 KHz. The tone may be arranged to emulate, for example, an ambulance siren which has been specifically selected to facilitate estimation of the direction from which the sound originates.

The survivors use the audio tones to reduce the search area, for example under the snow in the case of an avalanche, and hence locate the victims. The survivors are preferably able to switch the alert tone off on their own phones so that they do not interfere with detection.

Preferably the emergency alert message is broadcast using all the mobile operators providing a service within the relevant area. The emergency alert service may, in embodiments, only be made available in areas of high risk such as ski resorts, or it may only be turned on after a major event, such as an earthquake. This again helps to reduce the risk of wrongful use of the system.

The emergency alert response provided by a mobile phone may additionally or alternatively to an audio tone, comprise an rf response or rf beacon signal. Thus a mobile phone receiving an emergency alert message may transmit a repeated alert message response on a specified rf channel. This message may then be detected by means of a suitable receiver, for example including a directional antenna, and the mobile phone tracked down. Typically the search and rescue authorities are provided with the direction finding equipment required to locate the radio beacon signal. Such equipment is well known to the appropriately skilled person.

Such an rf beacon is potentially beneficial when victims are buried under a very large amount of debris through which an audio tone may not penetrate. However because radio receivers are required to locate the victims this arrangement will be of most use where the victims are likely to survive for some time, for example following an earthquake.

No doubt many other effective alternative embodiments will occur to the skilled person and the invention is not limited to the described embodiment.

We claim:

1. A method of using a communications system to assist in locating one or more mobile communications devices, the communications system including a mobile phone network to which the mobile communications systems devices are attached, the method comprising:
receiving an alert request signal at the mobile phone network; and
broadcasting an alert message to a plurality of said mobile communications devices in response to said alert request, said alert message comprising a message to cause each of said plurality of mobile communications devices to output an alert response to aid the location of the mobile communications device.

2. A method as claimed in claim 1 wherein said alert request signal is received from a requesting phone, the method further comprising storing an identification number of the requesting phone.

3. A method according to claim 1 wherein the mobile phone network is a cellular mobile phone network and wherein said plurality of mobile communications devices comprises substantially all the mobile communications devices in a cell of the network.

4. A method according to claim 1 wherein the mobile phone network is a cellular mobile phone network and wherein said plurality of mobile communications devices comprises substantially all the mobile communications devices in a sector of a cell of the network.

5. A method according to claim 1 further comprising:
sending an alert cancel message to one or more selected ones of said plurality of mobile communications devices to cause said selected mobile communications devices to cease outputting the alert response.

6. A method according to claim 1 further comprising:
sending an alert cancel message to said plurality of mobile communications devices a predetermined interval after broadcasting said alert message, to cause said mobile communications devices to cease outputting the alert response.

7. A method according to claim 1 wherein said alert response comprises an audio output.

8. A method according to claim 1 wherein said alert response comprises an rf transmission.

9. A method according to claim 8 wherein said rf transmission comprises an identification message.

10. A method according to claim 1 wherein said alert message comprises alert data to determine the type of alert response output by a said mobile communications device.

11. A method according to claim 1 further comprising:
receiving an alert enable message at said mobile phone network; and
enabling said broadcasting of an alert message in response to said alert enable message.

12. A carrier medium carrying computer program code to implement the method of claim 1.

13. A mobile phone network emergency controller including computer program memory storing the program code of claim 12.

14. A method of using a communication system including a mobile communications device attached to a mobile phone network to aid the location of the mobile communications device, the method comprising:
receiving an alert request signal at the mobile phone network; and
transmitting an emergency alert message to the mobile communications device, the emergency alert message comprising a message to cause the mobile communications device to output an emergency alert response to aid the location of the mobile communications device.

15. A method as claimed in claim 14 wherein the emergency alert response comprises an emergency rf transmission from the mobile communications device.

16. A method according to claim 15 wherein said emergency rf transmission comprises an identification message.

17. A carrier medium carrying computer program code to implement the method of claim 14.

18. A mobile phone network emergency controller including computer program memory storing the program code of claim 17.

19. A method of using a mobile communications device as an emergency location aid, the method comprising:
receiving an emergency alert message at the mobile communications device; and
outputting an emergency alert from the mobile communications device in response to said emergency alert message.

20. A method according to claim 19 wherein said emergency alert comprises an emergency rf transmission from the mobile communications device.

21. A method according to claim 20 wherein said rf transmission comprises an identification message.

22. A method according to claim 19 wherein said emergency alert comprises an audio emergency alarm.

23. A method according to claim 22 wherein said audio emergency alarm is selected to aid direction finding.

24. A method according to claim 22 wherein said outputting further comprises gradually increasing the volume of said audio emergency alarm from a safe level.

25. A method according to claim 19 wherein said emergency alert message comprises alert data, the method further comprising:
selecting said emergency alert response from a plurality of emergency alert responses in response to said alert data.

26. A method according to claim 19 further comprising:
ceasing outputting said emergency alert after a timeout period.

27. A method according to claim 19 further comprising:
receiving an alert cancel message; and
ceasing outputting said emergency alert in response to said alert cancel message.

28. A method according to claim 19 further comprising:
inputting an alert cancel message from a user of the mobile communications device; and
ceasing to output said emergency alert in response to said alert cancel message.

29. A carrier medium carrying computer program code to implement the method of claim 19.

30. A mobile communications device including computer program memory storing the computer program code of claim 29.
